(19) United States
(12) Patent Application Publication
(10) Pub. No.: US 2010/0038071 A1
(43) Pub. Date: Feb. 18, 2010

(54) Multi-Stage Spring For Use With Artificial Lift Plungers

(76) Inventors: William Tass Scott, Magnolia, TX (US); Mikel Trampus Wells, Magnolia, TX (US)

Correspondence Address: Law Offices of Tim Headley, 7941 Katy Fwy, Suite 506, Houston, TX, 77024-1924, US

(21) Appl. No.: 12/540,951

(22) Filed: Aug. 13, 2009

Related U.S. Application Data
(60) Provisional application No. 61/088,586, filed on Aug. 13, 2008.

(51) Int. Cl. F16F 3/00; E21B 43/00

(52) U.S. Cl. 166/105

(57) ABSTRACT

A multi-stage spring system, for use with an artificial lift plunger within an oil or natural gas well includes a first stage adapted for absorbing the initial impact of the artificial lift plunger, and for decreasing the momentum of the plunger, the first stage having a spring with a first spring rate. The spring system also includes a second stage in contact with the first stage, adapted for absorbing the remaining momentum of the plunger, the second stage having a spring with second spring rate greater than the first spring rate.

### CROSS-REFERENCES TO RELATED APPLICATIONS

This application claims the benefit of U.S. Provisional Application 61/088,586, filed Aug. 13, 2008.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC.

None.

### BACKGROUND OF THE INVENTION

(1) Field of the Invention

The invention relates to artificial lift plunger systems in oil and/or natural gas wells.

(2) Description of the Related Art

Many oil and natural gas wells employ artificial lift systems to prolong the production life of well formations. One type of artificial lift in wide use is a plunger lift. A plunger lift uses an independent device, or plunger, to travel down a wellbore to a predetermined depth, and return to the starting depth with fluid it encountered during its “trip”. This artificial lift system is used to clear the well of fluid that hinders the production of oil or natural gas. Plunger lift systems can be used in a variety of forms, all of which contain three components: surface equipment, a plunger, and down-hole or bottom-hole equipment.

Plungers have the potential to create massive impact forces on their downward trip in the well. Typically, a single coil spring is set at a predetermined depth to arrest these forces, and stop the plunger. Springs used in this method are, at times, inadequate for dealing with the energy produced by the falling plungers. A bottom-hole spring that is inadequately suited for the application can lead to prematurely worn-out plungers, broken plungers, and most likely a disabled and/or broken bottom-hole spring. A disabled or broken spring stuck in a wellbore is a time-consuming and costly set-back.

There are several prior art methods for dealing with the potential energy held within these plungers. One method involves the manipulation of flow rates within the well in order to apply a cushion of fluid at the bottom for the plunger to encounter before contact with the bottom-hole spring. This fluid column can absorb energy from the falling plunger sufficiently to reduce the impact force to within the spring's working impact range. Unfortunately, this can cause an overall reduction in the daily gas production of the well. The goal of plunger lift systems is to maximize the daily production of the well. Cutting back production on a well, in order to save equipment that is designed to maximize the well production, is contradictory. Another method for dealing with down-hole impacts is the installation of a single coil spring that is designed to withstand the possible impact forces caused by the plunger. However, several constraints exist that make this method impractical. Wellhead height, pipe inner diameter, and spring material characteristics are a few constraints that severely restrict this method's application.

U.S. Pat. No. 4,331,365 discloses a resilient support system having a two-stage spring arrangement for supporting a flexible bearing sheet.

U.S. Pat. No. 4,213,633 discloses shear rubber springs as full range springs, and vertically acting compression springs to provide helper or second stage springs essentially operative only under heavier loading.

U.S. Pat. No. 3,967,831 discloses an integral three-stage spring coil.

U.S. Pat. No. 6,336,626 discloses an improved stirrup suspension that utilizes a multi-stage spring suspension to accommodate the different downward forces generated during normal riding as well as jumping.

U.S. Pat. No. 6,571,868 (The entire disclosure of this patent is incorporated herein by this reference.) to Victor discloses a well head lubricator assembly with a polyurethane impact-absorbing spring which apparently withstands the impact forces generated by extremely high plunger speeds without failure compared to the conventional metal coil spring. This assembly discloses a surface arrestor spring, not a sub-surface spring. The urethane replaces the coil, and therefore provides only one rate of deceleration, not two.

U.S. Pat. No. 7,290,602 (The entire disclosure of this patent is incorporated herein by this reference.) to Victor discloses one or more internal shock absorbing elements and a variety of bypass orifice options. The internal spring is apparently used to replace the sub-surface spring assembly. The disclosed spring provides only a single stage of deceleration, not two.

U.S. Pat. No. 7,314,080 (The entire disclosure of this patent is incorporated herein by this reference.) to Giacomino discloses a slidable sleeve plunger for which when the plunger reaches the end of the well, the velocity of the plunger permits the end of the plunger to strike the bottom of the well, and the impact of the strike forces the sleeve of the plunger to slide down and close an entry orifice. The internal spring is apparently used to replace the sub-surface spring assembly. The disclosed spring provides only a single stage of deceleration, not two.

U.S. Pat. No. 7,328,748 (The entire disclosure of this patent is incorporated herein by this reference.) to Giacomino discloses a plunger having a thermal actuator which apparently enables the valve to open and close apertures without relying on the physical impact generally required of mechanical valve bypass plungers. The thermal actuator partially opens apertures to slow the plunger down as it approaches the top of a well. Likewise, the thermal actuator partially closes apertures to slow the plunger as it approaches the well bottom. The internal spring is not used as a force absorber. The disclosed spring apparently provides only a single stage of deceleration, not two.

U.S. Pat. No. 7,448,442 (The entire disclosure of this patent is incorporated herein by this reference.) to Wells discloses a plunger lift that uses a ball that is first dropped into the well onto a bumper. (Column 6, lines 24-34)

U.S. Pat. No. 7,523,783 (The entire disclosure of this patent is incorporated herein by this reference.) to Victor discloses a plunger mechanism that has an internal shock absorber apparatus that operates to absorb shock during plunger fall and rise. The internal spring is apparently used to replace the sub-surface spring assembly. The disclosed spring provides only a single stage of deceleration, not two.

Published U.S. Patent application no. 20060124294 (The entire disclosure of this published patent application is incorporated herein by this reference.) discloses a bypass plunger that has one or more internal shock absorbing elements within a captive actuator.

Thus, the known prior art has at least two major deficiencies. It lacks a spring system that can handle repeated impacts of a falling plunger (1) without using an enormously-sized spring, and (2) without decreasing the production flow of the well.

In light of the foregoing, a need remains for a plunger spring system that will not require a decrease in production from the well, and will not require a larger pipe diameter or a shallower well.

### BRIEF SUMMARY OF THE INVENTION

The present invention is a multi-stage spring system that arrests the downward forces created by falling artificial lift plungers. The spring system can be installed at a predetermined depth of a wellbore during the installation of an artificial lift plunger. The spring system comprises a first spring and a second spring that are separated by a mandrel.

### BRIEF DESCRIPTION OF THE SEVERAL VIEWS OF THE DRAWINGS

FIG. 1 is a cross-section of a two-stage mechanical spring system built according to the present invention. FIG. 1A shows the system at rest. FIG. 1B shows the system with the first stage mostly compressed. FIG. 1C shows the system with the first stage fully compressed, and the second stage partly compressed.

FIG. 2 is a cross-section of an alternate embodiment of a two-stage spring system, having a first-stage mechanical spring and a second-stage hydraulic spring. FIG. 2A shows the system at rest. FIG. 2B shows the system with the first stage mostly compressed. FIG. 2C shows the system with the first stage fully compressed, and the second stage partly compressed.

### DETAILED DESCRIPTION OF THE INVENTION

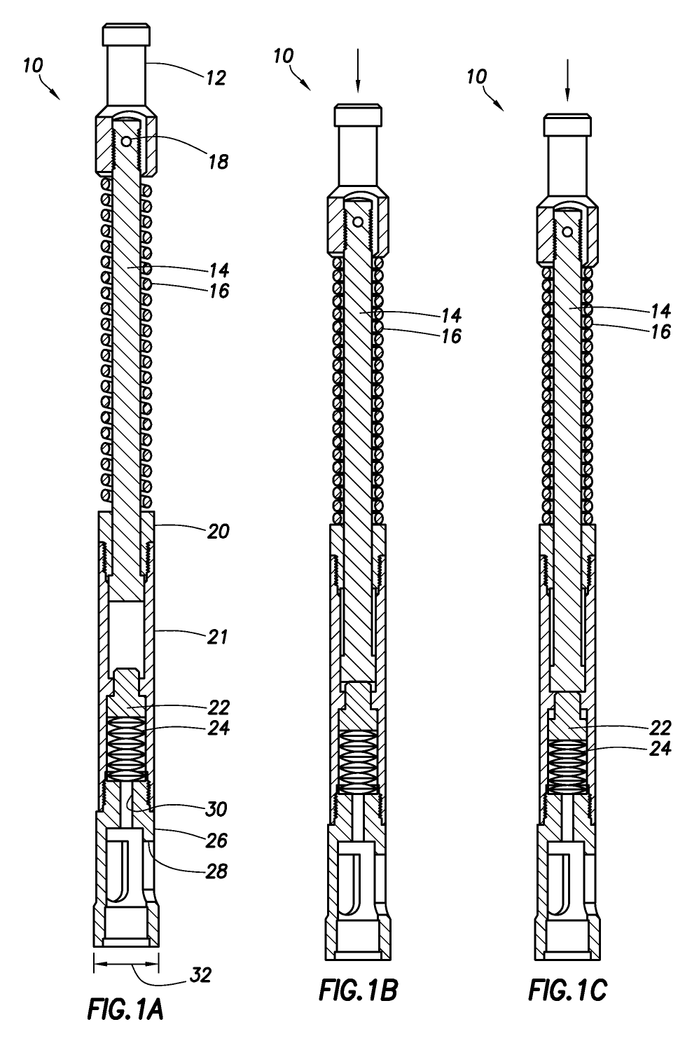

In FIG. 1A, a two-stage mechanical spring system 10 has a top sub 12 which is threaded onto a mandrel 14. A coil spring 16, manufactured by Diamond Wire Spring, located in Tyler, Tex., encircles the mandrel 14. The top of the coil spring 16 contacts the bottom side of the top sub 12. A pin lock 18 locks the top sub 12 onto the mandrel 14. The bottom of the coil spring 16 contacts the top of a spring cap 20, which is threaded onto a spring pack 21. The combination of the top sub 12, the coil spring 16, and the spring cap 20 constitute the first stage of the two-stage spring system. The mandrel 14 slides within the spring cap 20 and the spring pack 21. Also within the spring pack 21 in a sliding relationship is a pack driver 22. The top end of the pack driver 22 is adapted to be contacted by the bottom end of the mandrel 14. The bottom end of the pack driver 22 contacts the top of a stack of Belleville washers 24, which are also inside the spring pack 21. The bottom end of the spring pack 21 is threaded onto a bottom sub 26. The bottom of the stack of Belleville washers 24 rests on the top of the bottom sub 26, which contains cutouts 28, a drain hole 30, and an outside diameter 32 which is sized to rest on the industry standard seating nipples within the well bore tubing. Alternatively, a setting tool such as a collar stop or a tubing stop may be attached to the bottom sub 26. Thus, the system 10 may be inserted at any point within the well bore tubing, wherever the seating nipples are located, some distance above the bottom of the casing in the well bore. The combination of the pack driver 22, the stack of Belleville washers 24, and the bottom sub 26 constitute the second stage of the two-stage spring system.

Referring now to FIG. 1B, in operation a descending artificial lift plunger (not shown) strikes the top of the top sub 12, as indicated by the arrow at the top of FIG. 1B. The top sub 12 presses the mandrel 14 down, and also presses down against the coil spring 16. The coil spring 16 absorbs the initial impact of the plunger, slowing it down, and the mandrel 14 then contacts the pack driver 22 with a greatly reduced momentum.

Referring now to FIG. 1C, as the artificial lift plunger continues downward, the coil spring 16 becomes fully compressed, while simultaneously the stack of Belleville washers 24 become compressed until the descent of the plunger ends.

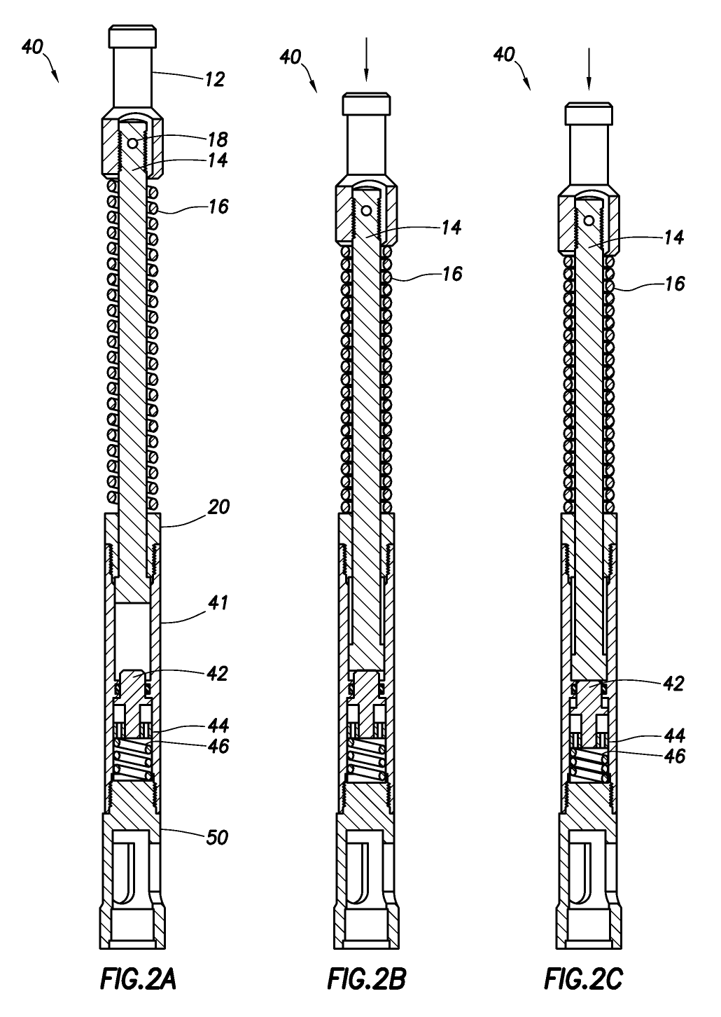

Referring now to FIG. 2A, an alternate embodiment of the present invention is a spring system 40 which includes a first-stage mechanical spring identical to the first-stage of the spring system 10, but has a second-stage hydraulic spring. Thus, the pack driver 22 is replaced with a hydraulic driver 42, which has an integral disc 44 with holes in it. The bottom of the hydraulic driver 42 rests on the top of a return spring 46. The hydraulic driver 42 and the return spring 46 are encased within, and in a sliding relationship with, a hydraulic pack 41. The space within the hydraulic pack 41 holding the return spring 46 is filled with oil. The bottom of the return spring 46 rests on the top of a bottom sub 50, which is threaded into the bottom of the hydraulic pack 41.

Referring now to FIG. 2B, in operation, a descending artificial lift plunger (not shown) strikes the top of the top sub 12, as indicated by the arrow at the top of FIG. 2B. The operation of the first stage of the spring system 40 is identical to the operation of the spring system 10.

Referring now to FIG. 2C, in operation, as the artificial lift plunger continues downward, the coil spring 16 becomes fully compressed, while simultaneously the oil inside the hydraulic pack 41 is forced upward through the holes in the disc 44 until the descent of the plunger ends.

For both spring systems 10 and 40, the contact between the first and second stages is set at a predetermined force load and/or travel distance. The first stage is set to have a spring rate, or spring constant, that is much lower than the spring rate of the second stage. The rate of a spring is the change in the force it exerts, divided by the change in deflection of the spring. The higher the impact force of the plunger, the stronger the springs in each stage. The spring system is not limited to merely two stages, but rather can be any number of stages that can be set at varying force loads and/or travel distances, as long as each stage after the first stage has a higher spring rate than the first stage. The components of the stages for the system of the present invention can be chosen from the group consisting of hydraulic springs, pneumatic springs, coil springs, washer springs, wave springs, non-Newtonian fluids, and magnets. The proper application of stage components and stage interaction by way of force load/travel distances reduces plunger wear and thus time to failure. Also, the reduction in height, outer diameter, and spring strengths make the multi-stage spring system adaptable to almost any well condition and/or diameter.

1. A multi-stage spring system, for use with an artificial lift plunger within an oil or natural gas well, comprising:
a. a first stage adapted for absorbing the initial impact of the artificial lift plunger, and for decreasing the momentum of the plunger, the first stage comprising a spring having a first spring rate; and
b. a second stage in contact with the first stage, adapted for absorbing the remaining momentum of the plunger, the second stage comprising a spring having a second spring rate;
wherein the second spring rate is greater than the first spring rate.

2. A multi-stage spring system, for use with an artificial lift plunger within the tubing situated inside the casing of an oil or natural gas well, comprising:
a. a first stage adapted for absorbing the initial impact of the artificial lift plunger, and for decreasing the momentum of the plunger, the first stage comprising a spring having a first spring rate;
b. a second stage in contact with the first stage, adapted for absorbing some of the remaining momentum of the plunger, the second stage comprising a spring having a second spring rate; and
c. a third stage in contact with the second stage, adapted for absorbing all of the remaining momentum of the plunger, the third stage comprising a spring having a third spring rate,
wherein the second spring rate is greater than the first spring rate, and the third spring rate is greater than the second spring rate.

3. A multi-stage spring system, for use with an artificial lift plunger within an oil or natural gas well, comprising multiple stages, each stage having a spring with a spring rate, wherein a first stage is adapted for absorbing the initial impact of the artificial lift plunger, and for decreasing the momentum of the plunger, the first stage comprising a spring having a first spring rate, the first stage in contact with the subsequent stage, all subsequent stages are in contact with each other, and all subsequent stages have springs with spring rates greater than the first spring rate.

4. A multi-stage spring system according to claims 1, 2, or 3, wherein the springs are selected from the group consisting of hydraulic springs, pneumatic springs, coil springs, washer springs, wave springs, non-Newtonian fluids, and magnets.
